(19) United States
(12) Patent Application Publication
(10) Pub. No.: US 2002/0046194 A1
(43) Pub. Date: Apr. 18, 2002

(54) Postal system, franking machine, and label allowing tracking and tracing of postal items

(76) Inventor: George G. Gelfer, West Chester, PA (US)

Correspondence Address: Schiff Hardin & waite, Patent Department, 6600 Floor Sears Tower, 233 South Wacker Drive, Chicago, IL, 60606, US

(21) Appl. No.: 09/887,994

(22) Filed: Jun. 22, 2001

(30) Foreign Application Priority Data
Jun. 23, 2000 (DE) 100 30 660.8

(51) Int. Cl. G06F 17/60

(52) U.S. Cl. 705/401; 705/1

(57) ABSTRACT

A postal system has one or more franking machines for printing postage indicia on mail and a postal service for delivering mail. A franking machine for use in such a postal system, in accordance with a method for tracking and tracing a piece of mail, has a printer for printing an identity code onto a label identifying one or more pieces of mail. The label is removably attachable on the respective piece of mail before sending it and is removed after delivery. The postal service includes units for tracking and tracing pieces of mail using the mail identity code printed onto the label. The label will be removed from a piece of mail when it is actually delivered to the addressee and is placed on a separate sheet of paper that will be scanned when the carrier returns to the local post office.

### BACKGROUND OF THE INVENTION

1. Field of the Invention

The present invention relates to a postal system of the type having one or more franking machines for printing postage indicia on mail and a postal service for delivering mail. The invention relates further to a franking machine for printing postage indicia on mail, to a label that is removably attachable to a piece of mail, and to a method for tracking and tracing a piece of mail.

2. Description of the Prior Art

A postal system including a carrier for delivering mail and a franking machine is described in German OS 197 33 605 A1. For each piece of mail an identity certificate is produced by the franking machine containing information about the respective piece of mail, such as the required fee and mailing parameters. The identity certificate is printed on a self-adhesive label which is adhered to the piece of mail. The information contained in the identity certificate can be used by the carrier for delivering and billing purposes by reading the data from the identity certificate in a data center of the carrier before delivering the piece of mail. Further, an identity code for the piece of mail can be included in the identity certificate, selectively in readable form or as a bar code, which may be used for searching for a piece of mail in case of mailing errors.

Postal services, in particular postal administrations and private carriers, desire to offer a track and trace capability for certain classes of mail, for which purpose it is desired that any form of identification for pieces of mail be provided, e. g. that a bar code be printed in some manner during the creation of the postage meter indicia. It is clear that a bar code printed to the left hand side of the postage meter indicia or anywhere else on the envelope will not be accepted, especially not by the postal administrations. This is because they have a very large number of letter carriers who are not equipped with handheld scanners, as are private carriers.

### SUMMARY OF THE INVENTION

An object of the present invention is to provide a postal system which offers a track and trace capability for pieces of mail, as well as a franking machine for use in such a postal system and a method for tracking and tracing a piece of mail.

These objects are achieved in a postal system and method according to the invention wherein a label is applied to the piece of mail, e. g. a letter, that contains some sort of identity code, e. g. bar code information identifying one or more pieces of mail. This label is fixed on the letter before sending it, e. g. during the franking process, and will be removed from the letter and placed on a separate sheet of paper after delivery of the letter. The identity code will then be read when the carrier returns to the local post office, e. g. by using a scanner reading the bar code. It can then be used for tracking and tracing purposes, e. g. by sending a message to the sender informing the sender about the delivery.

According to the invention it is not required that any letter carrier be equipped with a handheld scanner or any other reading device for reading the identity code. There is also no need for writing the identity code by hand, which is time consuming. It is much easier and faster to remove a label from a letter, place it on a separate sheet of paper, and read all labels centrally using an automatic reader.

In a further development one or more readers can be provided at one or more different delivery stations for reading the identity codes, thus allowing monitoring of the exact route of the piece of mail. This enables the sender to always check where a piece of mail currently appears and facilitates tracking and tracing if any piece of mail gets lost during delivery. A storage memory can be used to store information about all pieces of mail during delivery in a large database which can be accessed by the carrier and, if required, by the sender or the sender's local post office.

Preferably the identity codes are printed in the form of bar codes on self-adhesive labels which can easily be removed without destroying the surface or the envelope of the piece of mail.

A franking machine in accordance with the invention has a printer for printing indicia on mail as well as identity codes onto labels. Preferably these steps are done in the franking machine with a compact printer unit simultaneously or in succession. The printer for printing the identity codes onto the labels can easily be combined with existing conventional franking machines. It is advantageous if the franking machine not only prints identity codes onto labels but also fixes the labels on the pieces of mail.

A label in accordance with the invention is easily fixable to and removable from a piece of mail and for use in a franking machine in accordance with the invention.

### DESCRIPTION OF THE DRAWINGS

FIG. 1 is a block diagram of a postal system constructed and operating according to the invention,

FIG. 2 shows a piece of mail with a label thereon in accordance with the invention, and

FIG. 3 shows a franking machine in accordance with the invention.

### DESCRIPTION OF THE PREFERRED EMBODIMENTS

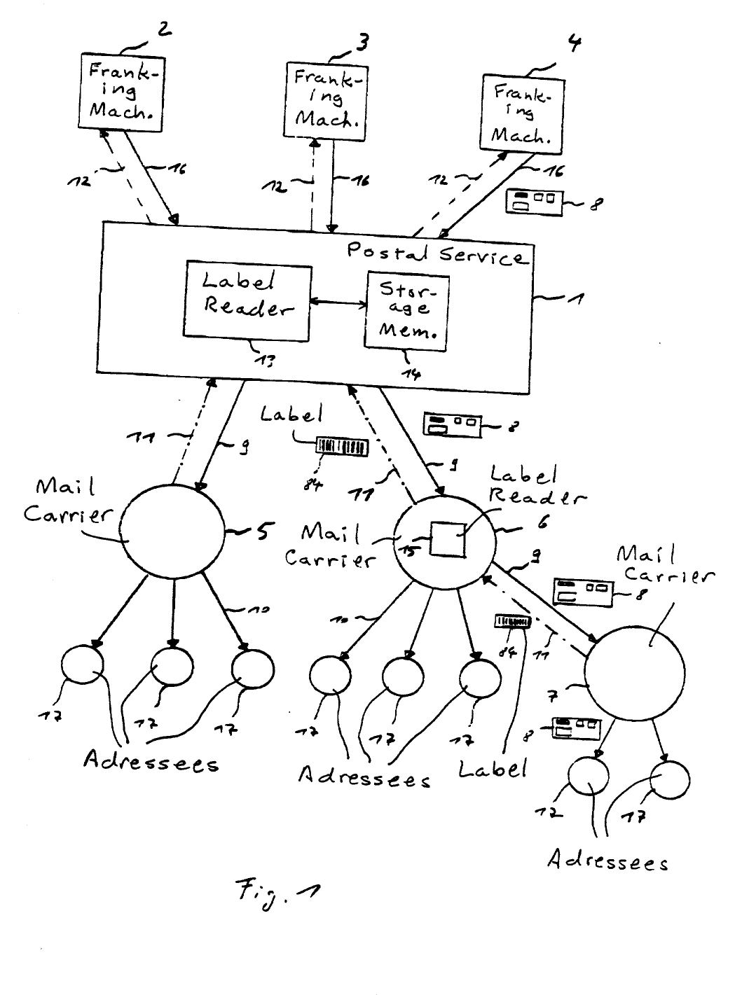

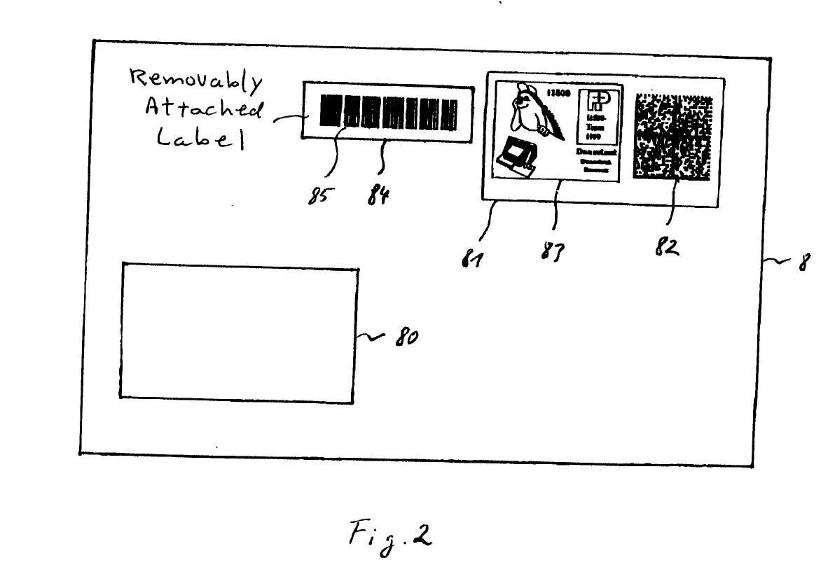

In FIG. 1 a block diagram of a postal system according to the invention is shown. This postal system has a central postal service I where all pieces of mail are collected, sorted and distributed to carriers 5, 6, 7 belonging to or working together with the postal service 1 for delivering the pieces of mail. The postal system further includes franking machines 2, 3, 4 where pieces of mail are franked as usual and where postage meter indicia for a class of mail can be printed on the pieces of mail. For a class of mail that is covered by a track and trace requirement, a label 84 is prepared by printing the required identity code onto the label in the form of a bar code 85 containing the track and trace operation (see FIG. 2). Thereafter the label can be a fixed automatically or by hand to the respective piece of mail 8 and put into the mailbox from where it is transported to the central postal service 1 as indicated by arrows 16.

The postal service 1 has a reader 13 for reading the identity code and a storage memory 14 for storing the identity codes read from pieces of mail in a database for tracking and tracing purposes. Thereafter the pieces of mail are transported to several carriers 5, 6, 7 (arrows 9) from where they are finally delivered to the addressees 17 (arrows 10). During the delivery the piece of mail 8 can go through several stations of carriers 6, 7 until it reaches an addressee 17.

When the piece of mail 8 is actually delivered to an addressee 17, the label 84 with a printed bar code on it is removed from the piece of mail 8 and sent back to the central postal service 1 via the same or another route as the piece of mail 8 (arrows 11). This can easily be done by putting all labels 84 on one or more sheets of paper and transporting them back to the postal service 1. In the postal service 1 the bar codes of these labels are read and are used to send a message back to the sender 2, 3 or 4 (arrows 12) informing the sender about successful delivery of his piece of mail 8. Further, in the central database of the storage memory 14, the respective identity code can be marked as delivered and/or deleted immediately or after a delay of some time.

One or more of the carriers 5, 6, 7 can be equipped with a reader 15 for reading the identity codes during delivery of the mail in order to register and monitor each station during delivery. An immediate response can also be sent back to the postal service 1 and, if required, to the sender 2, 3 or 4.

The postal system according to the invention makes it possible to track and trace pieces of mail during and after delivery. Each single piece of mail can have a unique identity code printed on the label which can be used to search for it in case of a mailing mistake. A piece of mail 8 including a label 84 according to the invention is shown in FIG. 2. The envelope includes a window 80 for the address of the recipient of the mail, a postage indicia 81 comprising a two dimensional bar code including billing information and a banner 83 for private or advertising reasons. Further a self-adhesive label 84 is adhered to the envelope wherein a bar code 85 including the identity code is printed on a label 84. The position, size and form of the label 84 and the bar code 85 as shown are only examples, but are in general dependent on a standard that can be chosen by the postal administration and/or the carrier using these labels 84, It is further not necessary that bar codes be used. The identity code can be put onto the label 84 in any form but the form employed is preferably machine-readable. The identity code can be put onto the label 84 in encrypted form.

As the bar code 86 a “standard code 128” can be used, or any other standard. A simple tracking number, whose number of digits can be defined, is all that is required for the application so that there is no requirement for a two-dimensional bar code which can, however, be used if more information shall be included in the identity code.

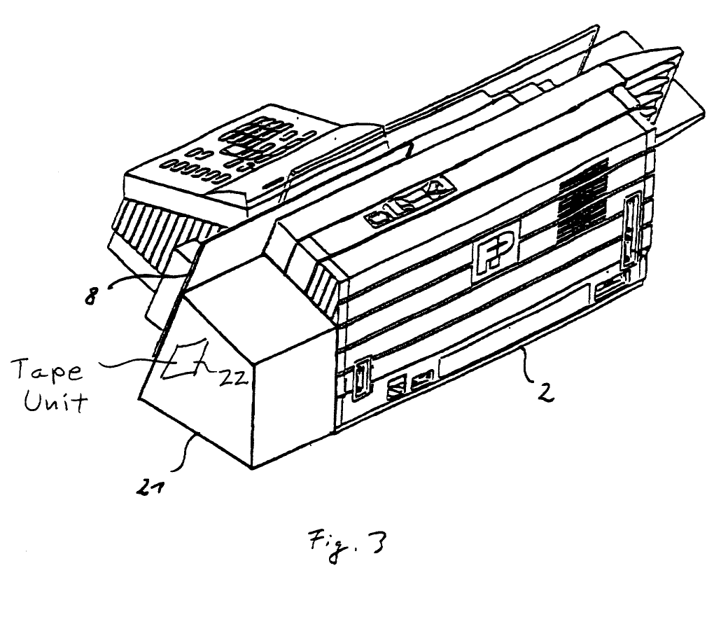

A franking machine in accordance with the invention is shown in FIG. 3. This franking machine 2 includes a separate unit 21 which can be combined with a standard franking machine and which is developed for printing the identity codes on labels and for putting the labels onto the piece of mail 8 after franking it as usual.

The separator unit 21 for franking machines according to the invention can have a tape unit 22. First the franking machine creates a postage meter indicia for a class of mail that is covered by a track and trace requirement and prints the indicia on the letter. Then the franking machine immediately causes a label to be printed that has the required bar code containing the track and trace operation. If there were twenty letters in the feeder requiring the track and trace bar code, each such franked letter is followed by a bar code label. This process is repeated until all the mail is processed. The information determining whether a track and trace bar code is required for a specific letter can come from a scale associated with the postage meter. Alternatively the information can be directly entered from the keyboard of the meter if no scale is present. The customer can affix the appropriate bar code label to its associated mail piece if the franking machine is not designed for doing this automatically.

The invention requires a special label stock, such as a backing sheet that has adhesive on both sides. One side is affixed to the letter and the other side to the label itself. The adhesive material associated with the label must be strong enough to run through conventional mail processing systems and at the same time must allow the postal delivery person to easily remove it and attach it to the required track and trace sheet for later scanning. An alternative to this approach would be to use something similar to Post It® stock. In this case it has to be ensured that this label would not come off during normal postal system processing.

If a manually fed, stand alone franking machine without a tape unit is used, it is still possible to realize the track and trace capability, as follows:

For a class of mail requiring the track and trace bar code label, the customer first enters the envelope in the meter to print the normal postage meter indicia. After the postage meter impression is made the display indicates a message such as “insert label”. In this case the meter would not dispense additional postage until the label had been inserted and printed. If the meter in question has limited display capabilities the numeric display can indicate a series of lines that roughly approximate a bar code indicating to the customer that a label had to be placed into the machine for processing. The label in question has the same characteristics as described above, however, it would be available in the normal “2 up” or “pinwheel” formats currently used by this class of product.

A batch-mail mode can be provided in which several identical labels are generated for several pieces of mail

Although modifications and changes may be suggested by those skilled in the art, it is the intention of the inventor to embody within the patent warranted hereon all changes and modifications as reasonably and properly come within the scope of his contribution to the art.

I claim as my invention:

1. A postal system comprising:
a franking machine having a printer arrangement for printing postage indicia on a mail item at a first location on said mail item;
a label disposed on said mail item at a second location, different from said first location, said label having an identity code printed thereon and being removably attached to said mail item; and
a postal service operated tracking and tracing arrangement for interacting with said label after removal thereof from said mail item after delivery of said mail item, using said identity code.

2. A postal system as claimed in claim 1 wherein said tracking and tracing arrangement includes a reader for reading said identity code after removal of said label from said piece of mail, and a storage unit for storing a plurality of identity codes respectively from a plurality of different labels.

3. A postal system as claimed in claim 1 wherein said tracking and tracing arrangement includes a reader for reading said identity code at at least one delivery station for said mail item.

4. A postal system as claimed in claim 1 wherein said second printer prints said identity code as a bar code.

5. A postal system as claimed in claim 1 wherein said second printer prints an identity code which uniquely identifies said mail item at said second location on said mail item.

6. A franking machine and label combination comprising:
a franking machine having a printing arrangement for printing postage indicia on a mail item; and
a label which is removably attachable to said mail item after delivery thereof, said printing arrangement printing an identity code on said label identifying said mail item, allowing tracking and tracing of said mail item after delivery thereof.

7. A franking machine and label combination as claimed in claim 6 wherein said printing arrangement prints said identity code as a bar code.

8. A franking machine as claimed in claim 6 wherein said printing arrangement prints an identity code on said mail item uniquely identifying said mail item.

9. A label comprising:
an indicia-receiving surface which is removably attachably to a mail item, said indicia-carrying surface having an identity code printed thereon identifying said mail piece and allowing tracking and tracing of said mail piece after delivery thereof.

10. A method for tracking and tracing a mail piece comprising the steps of:
printing an identity code onto a label identifying a piece of mail using a franking machine;
attaching said label to said mail piece, in a manner allowing subsequent removal of said label from said mail piece, before depositing said mail piece with a carrier;
removing said label from said mail piece after delivery of said mail piece by said carrier; and
machine-reading said identity code on said label and, if necessary, tracking and tracing said mail piece after delivery thereof using said identity code.

11. A method as claimed in claim 10 comprising reading said identity code at at least one delivery station for said mail piece.

12. A method as claimed in claim 10 comprising printing said identity code on said label as a bar code.

13. A method as claimed in claim 10 comprising printing an identity code on said mail piece which uniquely identifies said mail piece.
